(19) United States
(12) Patent Application Publication
(10) Pub. No.: US 2007/0229015 A1
(43) Pub. Date: Oct. 4, 2007

(54) Driving mechanism controller and driving mechanism control method

(75) Inventors: Masaya Yoshida, Himeji-Shi (JP); Hirohiko Goto, Akashi-Shi (JP)

Correspondence Address: OLIFF & BERRIDGE, PLC, P.O. BOX 19928, ALEXANDRIA, VA, 22320, US

(73) Assignee: KAWASAKI JUKOGYO KABUSHIKI KAISHA, KOBE-SHI (JP)

(21) Appl. No.: 11/727,368

(22) Filed: Mar. 26, 2007

(30) Foreign Application Priority Data
Mar. 28, 2006 (JP) 2006-89245

(51) Int. Cl. B25J 5/00; G06F 19/00

(52) U.S. Cl. 318/568.21; 318/568.12; 700/245

(57) ABSTRACT

A driving mechanism controller and a driving mechanism control method reduce damage to members caused by a collision. A command producing unit produces, upon the perception of the collision of a hand with an obstacle, a reversing signal for reversing a moving direction in which the hand is being moved by a motor and a position maintaining command requesting maintaining the hand at a position with respect to a direction perpendicular to the moving direction to which the hand has been displaced by the collision. After the detection of the collision of the hand with the obstacle, the hand is retracted maintaining the hand at the position to which the hand has been dislocated by the collision to separate the hand from the obstacle. Thus a pushing force exerted by the hand on the obstacle in the direction perpendicular to the moving direction is suppressed while the hand is separated from the obstacle.

### BACKGROUND OF THE INVENTION

1. Field of the Invention

The present invention relates to a driving mechanism controller and a driving mechanism control method for controlling a driving mechanism when a moving unit driven by the driving mechanism collides with an obstacle.

2. Description of the Related Art

A servomotor control method disclosed in, for example, JP-A 2001-117618 (Patent document 1) supplies a current to a servomotor so as to reverse torque that has been exerted on a hand upon the detection of the collision of the hand with an obstacle. The direction of motion of the hand is reversed by thus reversing the torque exerted on the hand to avoid pressing the hand further against the obstacle so that damage to the component members caused by collision may be limited to the least possible extent.

FIG. 11 is a view of assistance in explaining the operation of a carrying robot 2 for carrying semiconductor wafers (hereinafter, referred to simply as “wafer”) 1 when one of its hands comes into a head-on collision with the wafer 1. When one of the hands 4 collides with the wafer 1, the carrying robot 2 retracts the hands 4 so that the hands 4 follow reversely a route along which the hands have been advanced.

The hands 4 of the carrying robot 2 are arranged vertically along vertical directions Z and can move in the vertical directions Z. Each hand 4 extends in a moving direction X perpendicular to the vertical directions Z to support the wafer 1 thereon. The carrying robot 2 moves the hands 4 supporting the wafers 1 thereon in a first moving direction X1 to carry the wafers 1 into a vertical diffusion furnace and loads the wafers 1 on a wafer boat 3 to process the wafers 1 by a thermal process. In some cases, the wafers 1 are caused to warp and crack by thermal stress when the wafers 1 are processed by a thermal process. The warped and cracked wafers 1 are dislocated on the wafer boat 3. When the hands 4 are moved in the first moving direction X1 toward the warped and cracked wafers 1 to take out the wafers 1 from the vertical diffusion furnace, it is possible that the hands 4 collide with the wafers 1. Upon the detection of collision of the hand 4 with the wafer 1, the carrying robot 2 retracts the hands 4 in a second moving direction X2. Thus the hands 4 are prevented from being further pressed against the wafers 1 to limit damaging the wafers 1 and the hands 4 to the least possible extent.

If the hand 4 comes into a head-on collision with the wafer 1 as shown in FIG. 11, the hands 4 are retracted reversely along a route along which the hands 4 have been advanced before the hand 4 collides with the wafer 1. Thus damage to the component members of the carrying robot 2 can be limited to the least possible extent. However, the following problems arise if the hand 4 comes into oblique collision with the wafer, in which a force is exerted on the wafer 1 not only in the moving direction of the hand 4, but also in a direction perpendicular to the moving direction of the hand 4.

FIG. 12 illustrates a condition where the hand 4 of the carrying robot 2 is in oblique collision with the wafer 1. Suppose that the wafer 1 is caused to crack by the thermal process and is inclined so as to slope up in a second moving direction X2 opposite the first moving direction X1. Then, the hand 4 moving in the first moving direction X1 comes into oblique collision with the lower surface 5 of the inclined wafer 1. Consequently, forces act on the hand 4 in the second moving direction X2 and a second vertical direction Z2 opposite a first vertical direction Z1. The hand 4 is held at a position with respect to the vertical directions Z by a motor. When a force acting in the second vertical direction Z2 on the hand 4 exceeds a force maintaining the hand 4 at the position with respect to the vertical directions Z, the hand 4 is displaced in the second vertical direction Z2. If the hand 4 thus came into oblique collision with the wafer 1 is retracted simply reversely along a route along which the hand 4 has been advanced, the hand 4 is moved in the second moving direction X2 while the same is being moved in the first vertical direction Z1. Then, the hand 4 pushes the wafer 1 in the first vertical direction after collision, the normal wafer 1 and the hand 4 under the cracked wafer 1 are damaged, and the wafer boat 3 holding the wafers 1 is damaged.

Although pressing the hand 4 further against the wafer 1 after collision can be thus avoided when the hand 4 comes into oblique collision with the wafer 1, the hand 4 pushes the wafer 1 in the vertical direction perpendicular to the moving direction and damaging the component members cannot be surely prevented. Such a problem is not particular to the carrying robot 2 for carrying wafers 1 and is a general problem in controllers for controlling driving mechanisms.

### SUMMARY OF THE INVENTION

Accordingly, it is an object of the present invention to provide a driving mechanism controller capable of limiting damage that may be caused to members by collision to the least possible extent. Another object of the present invention is to provide a driving mechanism control method to be carried out by the driving mechanism controller.

A driving mechanism controller according to the present invention for controlling a driving mechanism for driving a movable body for movement includes a command producing means capable of giving a movement restricting command requesting restricting the movement of the movable body driven by the driving mechanism for movement in a moving direction in which the driving mechanism has been moving the movable body before the movable body collides with an obstacle, and a position maintaining command requesting maintaining the movable body at a position with respect to a direction perpendicular to the moving direction to which the movable body has been displaced by collision to the driving mechanism in response to a collision detection signal given thereto by a collision detecting means upon the detection of the collision of the movable body driven by the driving mechanism with the obstacle.

Preferably, the driving mechanism includes a first driving device for driving the movable body for movement in a predetermined first-direction and a second driving device for driving the movable body for movement in a second direction perpendicular to the first moving direction, and the command producing means provides a moving direction reversing command requesting reversing the moving direction of the movable body being moved in the first moving direction and a position maintaining command requesting maintaining the movable body at a position with respect to the second direction to which the movable body has been displaced by the collision to the driving mechanism upon the collision of the movable body moving in the first moving direction with the obstacle.

Preferably, the driving mechanism controller further includes a current limiting means for limiting currents supplied to first and second electric motors respectively serving as the first and the second driving device in response to the collision detection signal, and a current generating circuit capable of generating currents to be supplied to the first and the second electric motors on the basis of a command provided by the current limiting means.

Preferably, the current limiting means limits a current to be supplied to the second electric motor below a current needed by the second electric motor to move the movable body in the second direction, while the movable body is being moved in the first moving direction.

Preferably, the driving mechanism controller includes the collision detecting means, wherein the collision detecting means detects the collision of the movable body with an obstacle on the basis of the displacement of the movable body in the second direction.

Preferably, the driving mechanism controller includes the collision detecting means, wherein the collision detecting means detects the collision of the movable body with an obstacle on the basis of a displacement of the movable body in a direction in which the driving mechanism moves the movable body and a displacement of the movable body in a direction perpendicular to the moving direction.

A robot according to the present invention includes: a hand; a driving mechanism for driving the hand for movement; and the driving mechanism controller according to the present invention.

A driving mechanism control method of controlling a driving mechanism for driving a movable body for movement according to the present invention includes the steps of: detecting the collision of the movable body driven by the driving mechanism with an obstacle; restricting the movement of the movable body in a moving direction in which the movable body is moved before the movable body collides with the obstacle upon the detection of the collision of the movable body with the obstacle; maintaining the movable body at a position to which the movable body has been displaced in a direction perpendicular to the moving direction by collision upon the detection of the collision of the movable body with the obstacle.

A program according to the present invention is intended to be executed by a computer to carry out the driving mechanism control method.

The command producing means of the driving mechanism controller according to the present invention produces a movement restricting command requesting restricting the movement of the movable body in the moving direction upon the perception of the collision of the movable body with the obstacle from the collision detection signal received from the collision detecting means. The driving mechanism displaces the movable body on the basis of the movement restricting command. Thus the movable body is restrained from movement in the moving direction to prevent the movable body from being further pressed against the obstacle after the collision.

The command producing means produces a position maintaining command requesting maintaining the movable body at a position with respect to a direction perpendicular to the moving direction to which the movable body has been displaced by the collision upon the perception of the collision of the movable body with the obstacle from the collision detection signal received from the collision detecting means. The driving mechanism displaces the movable body on the basis of the position maintaining command. Thus the driving mechanism holds the movable body at a position with respect to a direction perpendicular to the moving direction to which the movable body has been displaced by the collision. Since a command requesting maintaining the movable body at a predetermined position with respect to a direction perpendicular to the moving direction in a normal state is changed for a command requesting maintaining the movable body at the position with respect to a direction perpendicular to the moving direction to which the movable body has been displaced by the collision upon the collision of the movable body with the obstacle, the movable body is held at the position to which the same has been displaced by the collision. Consequently, exertion of a thrusting force by the movable body on the obstacle to thrust the obstacle aside can be suppressed and hence damage to the movable body and the obstacle can be reduced to the least possible extent. According to the present invention, the command producing means provides a moving direction reversing signal requesting reversing the moving direction of the movable body being moved in the first moving direction upon the perception of the collision of the movable body being moved in the first moving direction with the obstacle from the collision detection signal. The first driving device reverses the moving direction of the movable body moving in the first moving direction in response to the moving direction reversing command. Thus the obstacle can be prevented from being pushed further in the first moving direction.

According to the present invention, the command producing means produces a position maintaining command requesting maintaining the movable body at a position with respect to the second direction to which the movable body has been displaced by the collision upon the collision of the movable body moving in the first moving direction with the obstacle. The second driving device drives the movable body on the basis of the position maintaining command to hold the movable body at the position with respect to the second direction to which the movable body has been displaced by the collision. Since the command requesting maintaining the movable body at the predetermined position with respect to the second direction in a normal state is changed for a command requesting maintaining the movable body at the position with respect to the second direction to which the movable body has been displaced by the collision upon the collision of the movable body with the obstacle, the movable body is held at the position to which the same has been displaced by the collision. Thus the movable body is reversed while the movable body is held at the position with respect to the second direction to which the movable body has been displaced by collision. Consequently, exertion of a thrusting force by the movable body on the obstacle to thrust the obstacle in the second direction can be suppressed when the movable body is separated from the obstacle and hence damage to the movable body and the obstacle can be reduced to the least possible extent.

According to the present invention, the current limiting means limits currents supplied to the first and the second electric motor upon the perception of the collision of the movable body with the obstacle from the collision detection signal. A time needed to accomplish limiting the current after the detection of the collision is shorter than a time needed to accomplish reversing the current after the detection of the collision. The current generating circuit generates currents on the basis of the command provided by the current limiting means, Therefore, the forces exerted in the first moving direction and the second direction on the obstacle by the movable body can be reduced even if the completion of reversing the moving direction of the movable body moving in the first moving direction and completion of maintaining the movable body at the position to which the same has been displaced are delayed. The force exerted by the movable body on the obstacle after the collision can be reduced. Therefore, impacts on the movable body and the obstacle can be eased when the movable body comes into head-on or oblique collision with the obstacle.

According to the present invention, the current supplied to the second electric motor is limited to a level below that of a current necessary for moving the movable body in the second direction, while the movable body is moving in the first moving direction. Although the current supplied to the first electric motor cannot be reduced to a low level while the movable body is moving in the first moving direction, the movement of the movable body in the first moving direction is not affected at all even if the current supplied to the second electric motor is limited to the level below that of a current necessary for moving the movable body in the second direction. A repulsive force exerted on the obstacle by the movable body in the second direction is low when the movable body collides with the obstacle while the currents are supplied in the foregoing mode to the electric motors. Consequently, impacts on the movable body and the obstacle can be eased still further.

According to the present invention, the collision detecting means detects the collision of the movable body with an obstacle on the basis of at least a displacement of the movable body in the second direction. Velocity and acceleration of the movable body in the second direction can be determined on the basis of the displacement of the movable body in the second direction. The detection of the collision of the movable body with the obstacle from the displacement of the movable body in the second direction includes the detection of the collision of the movable body with the obstacle on the basis of at least either of the velocity and the acceleration of the movable body with respect to the second direction. The current supplied to the second electric motor is limited to a level below that of a current necessary for moving the movable body in the second direction while the movable body is moving in the first moving direction. Therefore, a repulsive force exerted by the movable body on the obstacle in the second direction is low when the movable body collides with the obstacle. Therefore, the movable body collided with the obstacle is displaced greatly in the second direction. The collision detecting means can accurately detect the collision of the movable body with the obstacle on the basis of the great displacement of the movable body in the second direction. Since the movable body is displaced, the velocity of the movable body changes and the acceleration of the movable body changes to a level that can be detected by the collision detecting means in a short time-after the collision, the collision detecting means can detect the collision in a short time after the collision and a procedure to be carried out after the collision can be started in a short time after the collision.

According to the present invention, the collision detecting means detects the collision of the movable body with the obstacle on the basis of the displacement of the movable body with respect to the moving direction and the displacement of the same with respect to the direction perpendicular to the moving direction. The movable body is displaced greatly with respect to the moving direction when the movable body comes into head-on collision with the obstacle. The movable body is displaced greatly with respect to a direction different from the moving direction when the movable body comes into oblique collision with the obstacle. The collision detecting means capable of sensing both the displacement in the moving direction and the displacement in the direction perpendicular to the moving direction can surely detect the collision regardless of the mode of collision of the movable body with the obstacle, and the procedure to be carried out after the collision can be surely started.

According to the present invention, impacts applied to the members upon the collision of the hand with the obstacle can be eased and hence damage to the members can be reduced.

According to the present invention, when the collision of the movable body with the obstacle is detected in the step of detecting the collision of the movable body with the obstacle, the movable body is held at a position to which the movable body has been displaced in a direction perpendicular to the moving direction by the collision upon the detection of the collision of the movable body with the obstacle in the step of maintaining the position of the movable body. Since a command requesting maintaining the movable body at a predetermined position with respect to a direction perpendicular to the moving direction in a normal state is changed for a command requesting maintaining the movable body at the position with respect to a direction perpendicular to the moving direction to which the movable body has been displaced by the collision upon the collision of the movable body with the obstacle, the movable body is held at the position to which the same has been displaced by the collision. Consequently, exertion of a thrusting force by the movable body on the obstacle to thrust the obstacle in the direction perpendicular to the moving direction can be suppressed and hence damage to the movable body and the obstacle can be reduced to the least possible extent.

According to the present invention, the controller accomplishes its control function by executing the program read by the computer. Thus the pushing force exerted by the movable body on the obstacle can be suppressed and the driving mechanism can be controlled so as to reduce damage to the movable body and the obstacle.

### BRIEF DESCRIPTION OF THE DRAWINGS

The above and other objects, features and advantages of the present invention will become more apparent from the following description taken in connection with the accompanying drawings, in which:

FIG. 1 is a block diagram showing principal components of a robot 11 in a preferred embodiment according to the present invention;

FIG. 2 is a typical view of the robot 11 shown in FIG. 1;

FIG. 3 is a block diagram showing the physical construction of a controller 13;

FIG. 4 is a block diagram showing the functional construction of the controller 13;

FIG. 5 is a block diagram of a current limiter 26;

FIG. 6 is a flow chart of a control procedure to be carried out by the controller 13 when a hand collides with an obstacle;

FIG. 7 is a time chart showing variations of current position, current limiting mode and driving current with time;

FIG. 8 is a side elevation of a hand 17 and a semiconductor wafer 14 in a state where the hand 17 is in oblique collision with the semiconductor wafer 14;

FIG. 9 is a flow chart of a wafer unloading procedure to be carried out by the controller 13 to unload a semiconductor wafer 14 from a wafer boat 16;

FIG. 10 is a view of assistance in explaining a procedure for changing distances each between the adjacent hands 17;

FIG. 11 is a view of assistance in explaining the operation of a carrying robot 2 for carrying semiconductor wafers 1 when a hand 4 of the carrying robot 2 comes into head-on collision with a semiconductor wafer 1; and

FIG. 12 is a view of assistance in explaining the operation of the carrying robot 2 when the hand 4 of the carrying robot 2 comes into oblique collision with a semiconductor wafer 1.

### DESCRIPTION OF THE PREFERRED EMBODIMENTS

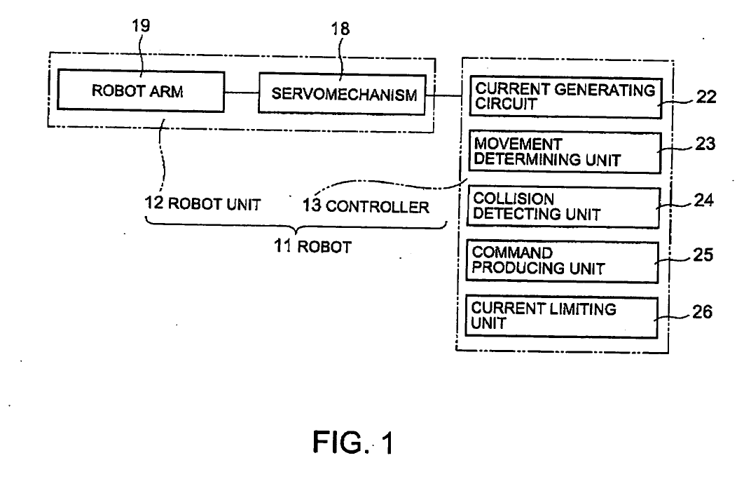

Referring to FIG. 1, a robot 11 in a preferred embodiment according to the present invention includes a robot unit 12, and a controller 13 for controlling the robot unit 12. The robot 11 carries a semiconductor wafer 14 (hereinafter, referred to simply as “wafer 14”) between a cassette 15 for holding wafers 14, and a wafer boat 16. The robot unit 12 includes a robot arm provided with hands 17, namely, movable bodies, and a servomechanism 18, namely, a driving mechanism. The robot arm 19 is movable. The servomechanism 18 is controlled by the controller 13 to-move the hands 17 by driving the robot arm 19 for movement.

The controller 13 controls the servomechanism 18 when the collision of the hand 17 with an obstacle is detected to suppress damage to component members caused by collision to the least possible extent. The obstacle is an object with which the hand 17 collides undesirably. For example, the obstacle is a wafer 14; there is a high possibility that the hand 17 collides with a wafer 14 when the robot 11 carries wafers 14.

The servomechanism 18 includes a driving device for driving the robot arm 19 for movement, and a transmission mechanism for transmitting the power of the driving device to the robot arm 19. A motion measuring device is incorporated into the driving device. In this embodiment, the driving device is an electric motor, such as a servomotor. The servomotor is provided with a rotary encoder 21 as the motion measuring device. The rotary encoder 21 measures the number of rotations of the output shat of the servomotor. The controller 13 includes a current generating circuit 22, a movement determining unit 23, a collision detecting unit 24, a command producing unit 25 and a current limiting unit 26. The movement determining unit 23 calculates a command current necessary for moving the hand 17 to a predetermined position. in a normal state where the hand 17 does not collides with an obstacle, a command current calculated by the movement determining unit 23 is given to the current generating circuit 22. The current generating circuit 22 generates a current specified by the command current and supplies the current to the servomotor. The current generating circuit 22 is an amplifier capable of generating a driving current for driving a motor according to the command current, namely, a servo amplifier.

The collision detecting unit 24 detects the collision of the hand 17 with an obstacle on the basis of a displacement of the hand 17, i.e., a motion of the hand 17. The collision detecting unit 24 decides that the hand 17 has collided with an obstacle on the basis of deviations of the velocity and acceleration of the hand 17 respectively from a set velocity and a set acceleration and provides a collision detection signal. Upon the reception of the collision detection signal from the collision detecting unit 24, the command producing unit 25 calculates a hand retracting route, along which the hand 17 is to be retracted, capable of suppressing damage that may be caused to members by the collision to the least possible extent and gives information about the calculated hand retracting route to the movement determining unit 23. Then, the movement determining unit 23 calculates a command current on the basis of the information received from the command producing unit 25 and gives the calculated command current to the current generating circuit 22.

The current limiting unit 26 receives the collision detection signal from the collision detecting unit 24, limits the command current calculated by the movement determining unit 23 and gives information about the limited command current to the current generating circuit 22. A current to be generated by the current generating circuit 22 is reduced below a current which has been generated by the current generating circuit 22 before the occurrence of the collision and the reduced current is supplied to the motor.

According to the present invention, limitation of a current may be either the reduction of the command current calculated by the movement determining unit 23 by a value obtained by multiplying the command current by a predetermined reduction ratio or limiting the current to a fixed current regardless of the command current determined by the movement determining unit 23. The predetermined reduction ratio includes 100%. If the predetermined reduction ratio is 100%, the current generating circuit 22 does not supply any current to the servomotor at all during current limitation.

The controller 13 is a robot controller provided with the collision detecting unit 24 and the current limiting unit 26 in addition to the components of an ordinary robot controller. The controller 13 may be the same in constitution as an ordinary robot controller, excluding the collision detecting unit 24, the current limiting unit 26 and the command producing unit 25.

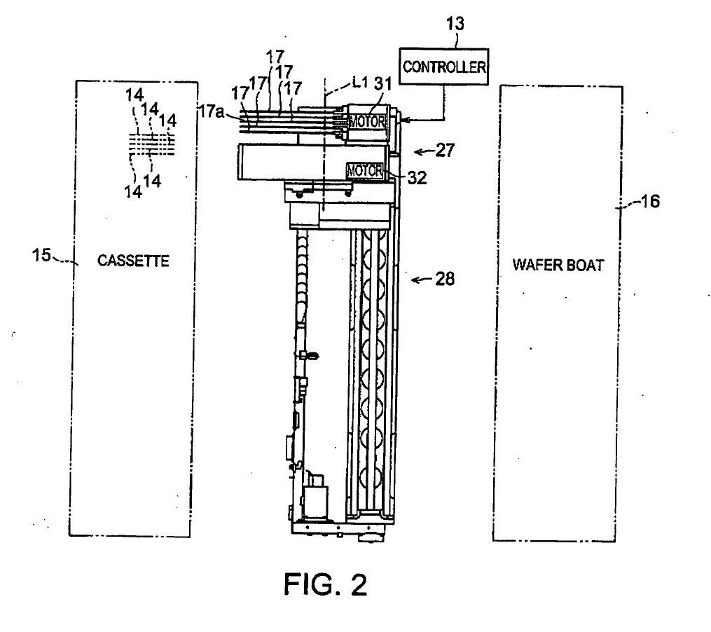

Referring to FIG. 2 typically showing the robot 11 in the preferred embodiment, the robot 11 includes a substrate holding device 27 for holding wafers 14, and a moving device 28 for moving the substrate holding device 27.

A plurality of semiconductor devices are formed on the wafer 14 by subjecting the wafer 14 to processes including an oxidation process, an annealing process, a chemical vapor deposition process (CVD process) and a diffusion process. The wafer 14 is a circular disk of, for example 300 mm in diameter and 0.7 mm in thickness.

The robot 11 transfers the wafers 14 from the cassette 15 to the wafer boat 16 contained in a semiconductor device fabricating device. After the wafers 14 have been processed by all the processes, the robot 11 transfers the wafers 14 from the wafer boat 16 to the cassette 15.

The cassette 15 and the wafer boat 16 are provided with support lugs for supporting the wafers 14 thereon. The wafers 14 are arranged vertically in a vertical direction Z in the cassette 15 and the wafer boat 16. The vertical direction Z is a second direction.

The cassette 15 holding the plurality of wafers 14 is delivered to a place near the semiconductor device fabricating device. Then the substrate holding device 27 carries the plurality of wafers 14 simultaneously and loads the wafer boat 16 with the wafers 14. The holding capacity of the cassette 15 is on the order of thirty wafers 14.

The wafer boat 16 is, for example a vertical wafer boat made of quartz. The wafer boat 16 is placed in the semiconductor device fabricating device. After the wafer boat 16 has been loaded with the wafers 14, the semiconductor device fabricating device processes the wafers 14 by a process, such as an oxidation process or a diffusion process. After the process has been completed, the robot 11 carries the processed wafers 14 simultaneously and returns the wafers 14 into the cassette 15. The cassette 15 holding the processed wafers 14 is carried to another semiconductor device fabricating device to subject the wafers 14 to a process in the next step of the semiconductor device fabricating process. The holding capacity of the wafer boat 16 is on the order of one hundred wafers 14.

The moving device 28 moves the substrate holding device 27 in the vertical direction Z. The moving device 28 turns the substrate holding device 27 about the axis L1 of the substrate holding device 27 parallel to the vertical direction Z.

The substrate holding device 27 is includes a robot arm 19 provided with the hands 17 for supporting the wafers 14 thereon, respectively, a pitch changing motor 31 for synchronously moving the hands 17 in the vertical direction Z, and a hand moving device 32 for moving the hands 17 in a moving direction X intersecting the vertical direction Z. In some cases, each of the pitch changing motor 31 and the hand moving device 32 is referred to as a motor M. The moving direction X is specified by a coordinate system set on the substrate holding device 27. In this embodiment, the moving direction X is a first horizontal direction. The moving direction X changes in a horizontal plane when the substrate holding device 27 is turned about the axis L1 by the moving device 28.

Each hand 17 is movable in the vertical direction Z. The hands 17 are arranged vertically at equal pitches. A pitch is a vertical distance between similar points on the adjacent hands 17. The hands 17 are interlocked so as to be simultaneously displaced vertically by the pitch changing motor 31 while the hands 17 are arranged at equal pitches. In this embodiment, the number of the hands 17 of the substrate holding device 27 is five. A first hand 17a, namely, the hand 17 at the middle of the vertical arrangement of the five hands 17, is not moved vertically on the substrate holding device 27 and the hands 17 excluding the first hand 17a are moved vertically to change the pitches. The hand moving device 32 includes a first hand moving motor 32a for moving the first hand 17a in the moving direction X and a second hand moving motor 32b for individually moving the hands 17 excluding the first hand 17a in the moving direction X. When the wafers 14 are taken out of the cassette 15 and when the wafers 14 are put into the cassette 15, the pitch changing motor 31 adjusts the pitches of the hands 17 to pitches at which the wafers 14 are arranged vertically in the cassette 15. When the wafers 14 are loaded on the wafer boat 16 and when the wafers 14 are unloaded from the wafer boat 16, the pitch changing motor 31 adjusts the pitches of the hands 17 to pitches at which the wafers 14 are arranged vertically on the wafer boat 16.

Each hand 17 is extended in the moving direction X and can be displaced in the moving direction X by the hand moving device 32. The robot 11 moves the hand 17 supporting the wafers 14 in the moving direction X to carry the wafers 14.

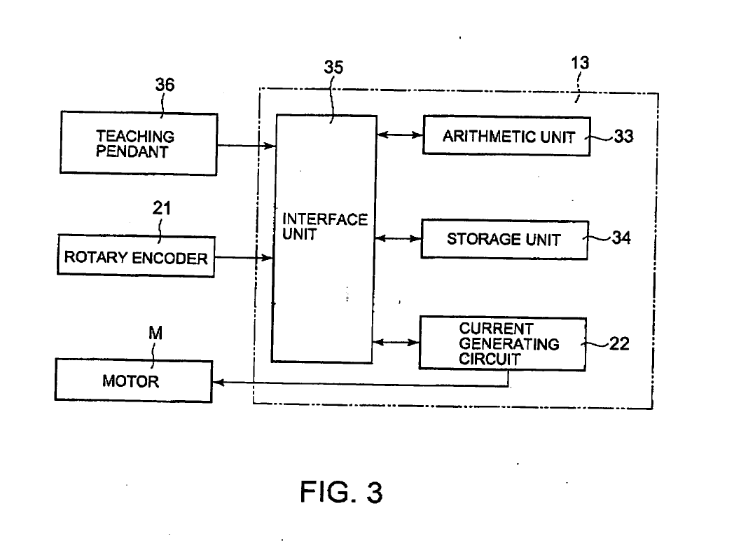

Referring to FIG. 3 showing the physical constitution of the controller 13, the controller 13 is a computer. The controller 13 executes a predetermined program to accomplish the functions of the movement determining unit 23, the collision detecting unit 24, the command producing unit 25 and the current limiting unit 26. The controller 13, namely, the computer can control the motors without delay.

The controller 13 includes an arithmetic unit 33, a storage unit 34, an interface unit 35 and the current generating circuit 22. The storage unit 34 stores a program specifies all or some of the functions of calculators, which will be described later. The arithmetic unit 33 reads the program stored in the storage unit 34 and executes operations specified by the program to accomplish all or some of the functions of the calculators. Even a controller different in physical constitution from the controller 13 of the present invention can function similarly to the controller 13 by reading the program stored in a storage medium without requiring substantial modification of its configuration. The controller 13 of the present invention can be easily realized only by changing software without adding pieces of hardware.

The arithmetic unit 33 is, for example, a CPU (central processing unit). The storage unit 34 is, for example, a RAM (random-access memory) or a ROM (read-only memory).

The program specifying operations to accomplish the functions of the calculators may be stored in another recording medium from which the computer can read the program. The arithmetic unit 33 reads the program from the storage medium and executes the program to accomplish all or some of the functions of the calculators. Information is transferred through the interface unit 35 between the arithmetic unit 33 and the storage unit 34. Information is transmitted through the interface unit 35 from the rotary encoder 21, a teaching pendant 36 and the current generating circuit 22 to the arithmetic unit 33 and from the arithmetic unit 33 to the rotary encoder 21, a teaching pendant 36 and the current generating circuit 22.

The arithmetic unit 33 generates a signal indicating a command position on the basis of information given thereto from the teaching pendant 36 or the information read from the storage unit 34. The arithmetic unit 33 receives position information about a position determined by the rotary encoder 21. The arithmetic unit 33 calculates command currents on the basis of those pieces of the information given thereto and gives the calculated command currents to the current generating circuit 22. The current generating circuit 22 generates currents corresponding to the command currents and supplies the currents to the pitch changing motor 31 and the motors of the hand moving device 32.

When the hand 17 collides with an obstacle, the arithmetic unit 33 decides whether or not the hand 17 has collided with an obstacle on the basis of the command position and the position determined by the rotary encoder 21. When it is decided that the hand 17 has collided with an obstacle, the arithmetic unit 33 limits the command currents supplied to the pitch changing motor 31 and the hand moving device 32, and gives signals indicating command currents to limit the movement of the hand 17 in the moving direction and to hold the hand 17 at a position with respect to a direction perpendicular t the moving direction to which the hand 17 has been displaced by collision to the current generating circuit 22.

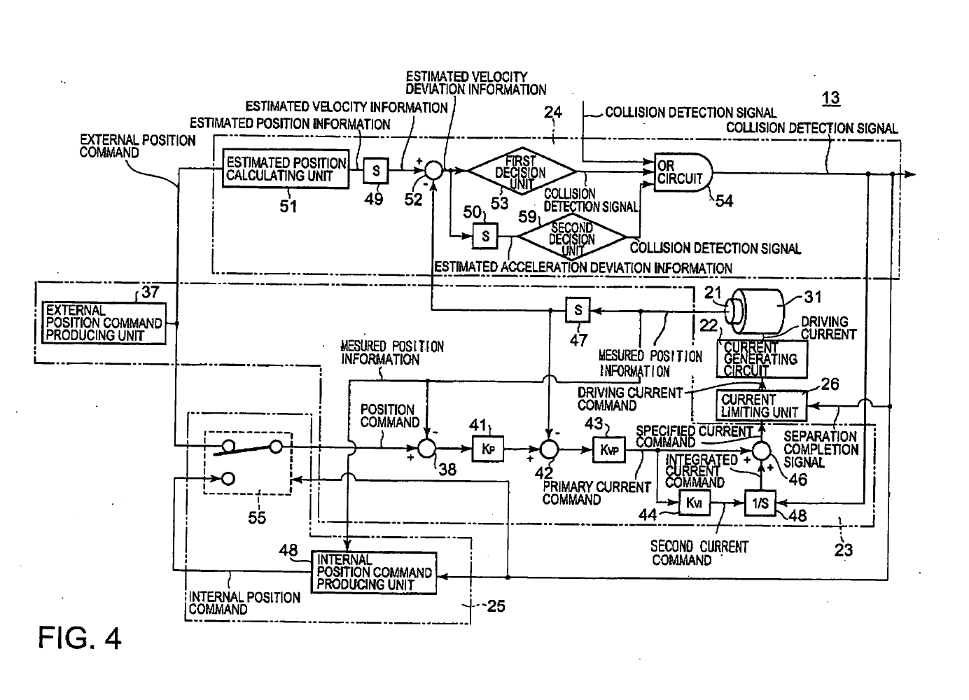

FIG. 4 is a block diagram showing the functional constitution of the controller 13. Functions of the movement determining unit 23, the collision detecting unit 24, the command producing unit 25 and the current limiting unit 26 can be accomplished by making the arithmetic unit 33 shown in FIG. 3 execute the program stored in the storage unit 34.

The movement determining unit 23 determines motor driving commands requesting driving the pitch changing motor 31 and the moving device 32 on the basis of the difference between a predetermined command position and a position measured by the rotary encoder 21. More concretely, the movement determining unit 23 includes an external position command producing unit 37, a positional deviation calculating unit 38, a first multiplier 41, a velocity deviation calculating unit 42, a second multiplier 43, a third multiplier 44, an integrator 45, an adder 46 and a feedback velocity calculating unit 47.

The external position command producing unit 37 provides a position command specifying positions on a predetermined taught route along which the hand 17 is to be moved. The position command is information about the positions of the hands 17 that change with time with respect to the moving direction X and the vertical direction Z. Therefore, the position command changes with time when the hands 17 are moved.

The controller 13 controls the pitch changing motor 31 for moving the hands 17 in the vertical direction Z, and another controller controls the operation of the hand moving device 32 for moving the hands 17 in the moving direction X. The controller 13 for controlling the pitch changing motor 31 will be described. As mentioned above, the first hand 17a, namely, the middle hand 17, among the hands 17 is not displaced by the pitch changing motor 31. Therefore, the hands 17 excluding the first hand 17a will be particularly described. The controller for controlling the hand moving device 32 is partly similar in constitution to the controller 13. Only parts of the controller for controlling the hand moving device 32 different from those of the controller 13 will be described.

The external position command producing unit 37 gives signals indicating command positions to the positional deviation calculating unit 38 while the hands 17 are moved normally without colliding with any obstacle. An internal position command producing unit 48, which will be described later, gives a signal indicating a command position to the positional deviation calculating unit 38 upon the collision of the hand 17 with an obstacle. The rotary encoder 21 gives measured position information about measured positions of the hands 17 with respect to the vertical direction Z to the positional deviation calculating unit 38. The hands 17 are kept at equal pitches while the hands 17 are moved in the vertical direction Z. Therefore, the measured position information indicates pitches of the hands 17.

The positional deviation calculating unit 38 subtracts the measured position information from the position command to obtain positional deviation information about a positional deviation. The positional deviation calculating unit 38 gives the calculated positional deviation information to the first multiplier 41.

The first multiplier 41 multiplies the positional deviation represented by the positional deviation information received from the positional deviation calculating unit 38 by a predetermined first coefficient Kₚ to obtain velocity information abut the velocity of the hand 17. The first gain Kₚ gives the calculated velocity information to the velocity deviation calculating unit 42.

The feedback velocity calculating unit 47 receives measured position information from the rotary encoder 21 every moment. The feedback velocity calculating unit 47 differentiates the position represented by the measured position information with respect to time to obtain feedback velocity information representing velocity. The feedback velocity calculating unit 47 gives the calculated feedback velocity information to the velocity deviation calculating unit 42 and an estimated velocity deviation calculating unit 52.

The velocity deviation calculating unit 42 subtracts the velocity represented by the feedback velocity information from the velocity represented by the velocity information received from the first multiplier 41 to obtain a velocity deviation information representing a velocity deviation. The velocity deviation calculating unit 42 gives the calculated velocity deviation information to the second multiplier 43. The second multiplier 43 multiplies the velocity deviation represented by the velocity deviation information received from the velocity deviation calculating unit 42 by a predetermined second gain Kᵥₚ to obtain a primary current command representing a first current to be given to the pitch changing motor 31.

The third multiplier 44 multiplies a change in the current represented by the primary current command by a predetermined third gain Kᵥᵢ to obtain a secondary current command representing a change in the second current and gives the secondary current command to the integrator 45. The integrator 45 integrates the changes in the second current represented by the secondary current command with respect to time to obtain an integrated current command representing the integral of the change of the second current.

The integrated current command and the primary current command are given to the adder 46. The adder adds up currents represented by the integrated current command and the primary current command to obtain a specified current command, which is information about a current to be given to the pitch changing motor 31. The adder 46 gives the specified current command to the current limiting unit 26.

While the hands 17 are moving in the normal state without colliding with any obstacle, the current limiting unit 26 does not limit the specified current command and gives the specified current command as a driving current command to the current generating circuit 22. The current generating circuit 22 generates a driving current specified by the driving current command and supplies the generated driving current to the pitch changing motor 31. The pitch changing motor 31 is driven by the driving current and moves the hands 17 in the vertical direction to change the pitches of the hands 17.

The adder 46 provides the specified current command by adding up the current specified by the primary current command and the current specified by the integrated current command to keep the hands 17 moving. For example, when the hands 17 are moved at a fixed speed to change the pitches, the hand 17 can be kept moving at a speed by giving the integrated current command to the adder 46 even in a state where the speed deviation is zero because the speed is equal to a desired speed and the primary current command is zero. The adder 46 serves as a current motion maintaining command producing unit for maintaining the current motion of the hand 17.

The first multiplier 41 may be similar to a multiplier employed in an ordinary robot controller for converting a position command into a velocity. The second multiplier 43 may be similar to a multiplier employed in an ordinary robot controller for converting a velocity into a current command.

The collision detecting unit 24 decides that the hand 17 collided with an obstacle when either of the estimated velocity deviation and the estimated acceleration deviation of the hand 17 exceeds a threshold. More concretely, the collision detecting unit 24 includes an estimated position calculating unit 51, an estimated velocity calculating unit 49, an estimated velocity deviation calculating unit 52, an estimated acceleration deviation calculating unit 50, a first decision unit 53, a second decision unit 59 and an OR circuit 54.

The estimated position calculating unit 51 estimates the respective theoretical positions of the hands 17. The time constant of the estimated position calculating unit 51 is approximately equal to that of the robot 11. The external position command producing unit 37 gives an external position command to the estimated position calculating unit 51. The estimated position calculating unit 51 calculates estimated theoretical positions of the hands 17 on the basis of the time constant set for the estimated position calculating unit 51, taking delays in the servomechanism into consideration. The estimated position calculating, unit 51 gives estimated position information about the calculated estimated positions to the estimated velocity calculating unit 49. When the positions of the hands 17 with respect to the vertical direction Z are fixed and the hands 17 are moved in the moving direction X, the estimated position calculating unit 51 gives estimated position information about a fixed position continuously to the estimated velocity calculating unit 49.

The time constant of the estimated position calculating unit 51 is determined on the basis of a delay corresponding to a time between the time the external position command is given and the time the hands 17 reach positions specified by the external position command. The estimated position calculating unit 51 calculates the theoretical positions of the hands 17 determined by taking the delay into consideration by filtering the external position command given thereto by a filter.

The estimated velocity calculating unit 49 differentiates the estimated position represented by the estimated position information with respect to time to obtain estimated velocity information about an estimated velocity. The estimated velocity calculating unit 49 gives the estimated velocity information to the estimated velocity deviation calculating unit 52. The feedback velocity calculating unit 47 gives feedback velocity information to the estimated velocity deviation calculating unit 52. The estimated velocity deviation calculating unit 52 subtracts a velocity represented by the feedback velocity information from the estimated velocity represented by the estimated velocity information to obtain estimated velocity deviation information about an estimated velocity deviation.

The first decision unit 53 receives the estimated velocity deviation information from the estimated velocity deviation calculating unit 52. The first decision unit 53 decides whether or not the estimated velocity deviation represented by the estimated velocity deviation information is greater than a predetermined first threshold. If the estimated velocity deviation is greater than the predetermined first threshold, the first decision unit 53 gives a collision detection signal indicated that the hand 17 has collided with an obstacle to the OR circuit 54.

The estimated acceleration calculating unit 50 receives the estimated velocity deviation information from the estimated velocity deviation calculating unit 52. The estimated acceleration calculating unit 50 differentiates the estimated velocity deviation represented by the estimated velocity deviation information with respect to time to obtain estimated acceleration deviation information about an estimated acceleration deviation. The estimated acceleration deviation information is given to the second decision unit 59.

The second decision unit 59 receives the estimated acceleration deviation from the estimated acceleration deviation calculating unit 50. The second decision unit 59 decides whether or not the estimated acceleration deviation represented by the estimated acceleration deviation information is greater than a predetermined second threshold. If the estimated acceleration deviation is greater than the second threshold, the second decision unit 59 gives a collision detection signal indicating the collision of the hand 17 with an obstacle to the OR circuit 54.

The OR circuit 54 receives a collision detection signal from the controller for controlling the hand moving device 32 in addition to those provided by the first decision unit 53 and the second decision unit 59. The controller for controlling the hand moving device 32 decides whether or not the hand 17 has collided with an obstacle on the basis of the estimated velocity deviation information and the estimated acceleration deviation information with respect to the moving direction X in which the hands 17 are moved. The controller gives a collision detection signal to the OR circuit 54 when the hand 17 collides with an obstacle. Upon the reception of the collision detection signal from at least one of the first decision unit 53, the second decision unit 59 and the controller for controlling the hand moving device 32, the OR circuit 54 decides that the hand 17 has collided with an obstacle and provides a collision detection signal. The collision detection signal provided by the OR circuit 54 is given to the internal position command producing unit 48, a selector switch 55, which will be described later, and the current limiting unit 26. The collision detection signal is given also to the controller for controlling the hand moving device 32.

The collision detecting unit 24 achieves collision detection on the basis of the estimated velocity deviations of the hand 17 with respect to the vertical direction Z and the moving direction X. Therefore, if either of the estimated velocity and the estimated acceleration with respect to either of the vertical direction Z and the moving direction X is different from the normal value, it is decided that the hand 17 collided with an obstacle. Even if the hand 17 is displaced only in a direction perpendicular to the moving direction by the collision, the collision detecting unit 24 can detect the collision of the hand 17 with an obstacle. Thus the collision detecting unit 24 can accurately detect not only a head-on collision, but also an oblique collision in which a force acts on the hand 17 also in a direction perpendicular to the moving direction.

The OR circuit 54 produces a collision detection signal on the basis of at least either of the estimated velocity deviation and the estimated acceleration deviation. The controller 13 can accurately percept the collision of the hand 17 with an obstacle. The collision causes the acceleration of the hand 17 to change faster than the velocity of the hand 17. Therefore the collision detection signal can be provided immediately after the occurrence of the collision when the collision is perceived on the basis of the estimated acceleration deviation.

When the hand 17 moving in the moving direction X comes into collision with an obstacle and is displaced in the vertical direction Z, the command producing unit 25 produces a position maintaining command requesting maintaining the hand 17 at a position with respect to the vertical direction Z to which the hand 17 has been displaced by the collision and gives the position maintaining command to the movement determining unit 23. The command producing unit 25 changes a command requesting maintaining the hand 17 at the predetermined position with respect to the vertical direction Z in a normal state for a command requesting maintaining the hand 17 at the position with respect to the vertical direction Z to which the hand 17 has been displaced by the collision upon the collision of the hand 17 with the obstacle.

When the hand 17 collides with an obstacle while the hand 17 is being moved in the vertical direction Z, the command producing unit 25 produces a retraction command requesting retracting the hand 17 so that the hand 17 follows reversely a route along which the hand 17 has been advanced before the hand 17 collides with the obstacle. The command producing unit 25 gives the retraction command to the movement determining unit 23. Thus the command producing unit 25 produces a command to restrain the hand 17 from movement in the vertical direction Z in which the hand 17 has been moved before the collision.

Upon the reception of the position maintaining command from the command producing unit 25, the movement determining unit 23 calculates a command current necessary for maintaining the hand 17 at the position with respect to the vertical direction Z to which the hand 17 has been displaced by the collision. The controller 13 executes control operations to hold the hand 17 at the position with respect to the vertical direction Z to which the hand 17 has been dislocated by the collision.

Upon the reception of the retraction command from the command producing unit 25, the movement determining unit 23 calculates a command current necessary for retracting the hand 17 in a retracting direction opposite the moving direction X. If the hand 17 collides with an obstacle while the same is being moved in the vertical direction Z, the controller 13 reverses the current being supplied to the pitch changing motor 31 to reverse the output torque of the pitch changing motor 31; that is, the controller 13 reverses the rotating direction of the output shaft of the pitch changing motor 31.

The command producing unit 25 includes the internal position command producing unit 48 and the selector switch 55. The internal position command producing unit 48 records position information about the position of the hand 17 determined by the rotary encoder 21 at all times. Upon the reception of the collision detection signal from the OR circuit 54, the internal position command producing unit 48 produces a internal position command, namely, a position maintaining command or a retraction command, from the recorded position information and gives the signal indicating the internal command position to the selector switch 55.

The command producing unit 25 reads the latest recorded position information and calculates the internal command position to produce the position maintaining command. The command producing unit 25 reads the stored position information in retrospective order from the latest position information and calculates the internal command position to produce the retraction command. The internal position command producing unit 48 may produce the internal position command from the latest position information among the time-sequential position information when the internal position command producing unit 48 has a limited storage capacity.

The selector switch 55 selects the external position command or the internal position command. The external position command producing unit 37 and the internal position command producing unit 48 give the external position command and the internal position command to the selector switch 55, respectively. In the normal state, the selector switch 55 transmits the external position command to the positional deviation calculating unit 38. When the OR circuit 54 applies a collision detection signal to the selector switch 55, the internal position command is transmitted to the positional deviation calculating unit 38.

When the hand 17 collides with an obstacle, the selector switch 55 transmits the internal position command to the positional deviation calculating unit 38. When the command producing unit 25 produces the position maintaining command, the second multiplier 43 calculates the primary current command indicating a current necessary for maintaining the hand 17 at the position with respect to the vertical direction Z to which the hand 17 has been dislocated by the collision. When the command producing unit 25 produces the retraction command, the second multiplier 43 calculates the primary current command indicating a current necessary for retracting the hand 17. The current generating circuit 22 supplies the current necessary for maintaining the hand 17 at the position with respect to the vertical direction Z to which the hand 17 has been dislocated by the collision to the pitch changing motor 31 when the command producing unit 25 gives the position maintaining command to the current generating circuit 22. The current generating circuit 22 supplies the current necessary for retracting the hand 17 to the pitch changing motor 31 when the command producing unit 25 gives the retraction command to the current generating circuit 22.

A command producing unit included in the controller for controlling the hand moving device 32 is provided with a collision detecting unit and a command producing unit different from those of the controller 13 for controlling the pitch changing motor 31. The collision detecting unit of the controller for controlling the hand moving device 32 produces a collision detection signal on the basis of at least either of the estimated velocity deviation and the estimated acceleration deviation and gives the collision detection signal to the collision detecting unit 24 of the controller 13 for controlling the pitch changing motor 31.

The command producing unit of the controller for controlling the hand moving device 32 executes a procedure reverse to the procedure to be carried out by the command producing unit 25 of the controller 13 for controlling the pitch changing motor 31. More concretely, when the hand 17 collides with an obstacle while the same is being moved in the moving direction X, the command producing unit produces a retraction command requesting retracting the hand 17 so that the hand 17 follows reversely a route along which the hand 17 has been advanced before the hand 17 collides with the obstacle. The command producing unit gives the retraction command to the movement determining unit 23. When the hand 17 collides with an obstacle while the same is being moved in the vertical direction Z, the command producing unit produces a position maintaining command requesting maintaining the hand 17 at a position with respect to the moving direction X to which the hand 17 has been dislocated by the collision, and gives the position maintaining command to the movement determining unit 23.

Upon the reception of the collision detection signal from the OR circuit 54, the integrator 45 is set to zero and starts integrating current changes indicated by the current command; that is, an integrated current command is reset to stop maintaining the moving operation of the hand 17 being performed in a period preceding the collision.

Thus the hand 17 is kept at the position with respect to the vertical direction Z to which the hand has been dislocated by the collision after the collision regardless of the velocity in the period preceding the collision. A specified current command indicating a current for retracting the hand 17 in the direction opposite the moving direction X can be promptly given to the current generating circuit 22. The current indicated by the specified current command can be reduced below the current supplied before the collision. Thus the current supplied to the pitch changing motor 31 can be reduced to reduce the pressure applied to the obstacle by the hand 17.

The OR circuit 54 gives a collision detection signal to the current limiting unit 26 when the hand 17 collides with an obstacle. Then, the current limiting unit 26 limits the current indicated by the specified current command and gives the specified current command indicating the limited current to the current generating circuit 22. Since the current limiting unit 26 is connected directly to the current generating circuit 22, the current supplied to the pitch changing motor 31 can be immediately reduced after the collision of the hand 17 with an obstacle.

In this embodiment, a set current range is set beforehand for the current limiting unit 26 to avoid supplying a high current exceeding an allowable current to the pitch changing motor 31 for a long time. In the normal state where the hand 17 is normally moving, the current limiting unit 26 gives a specified driving current command indicating the upper limit of the set current range to the current generating circuit 22 if the current indicated by the specified current command is higher than the upper limit of the set current range. The current limiting unit 26 gives a specified driving current command indicating the lower limit of the set current range to the current generating circuit 22 if the current indicated by the specified current command is lower than the lower limit of the set current range.

When it is decided that the hand 17 is retracted by a predetermined distance and is separated from an obstacle after the hand 17 has collided with the obstacle, the internal position command producing unit 48 provides a position command indicating a position where the hand 17 is to be stopped and gives a separation completion signal to the current limiting unit 26.

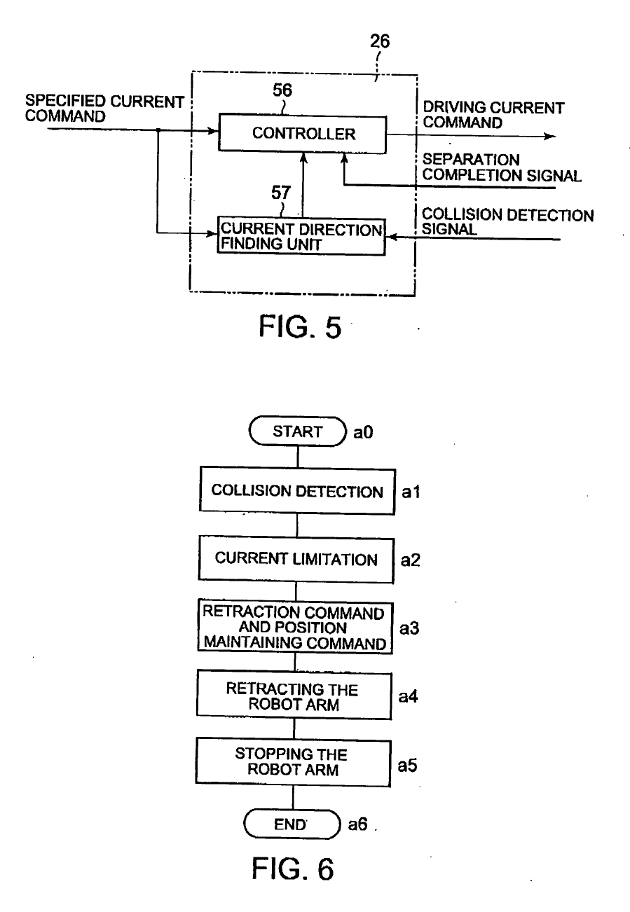

FIG. 5 is a block diagram of the current limiting unit 26. The current limiting unit 26 included in this preferred embodiment reduces the current indicated by the specified current command and corresponding to a current flowing in the same direction as a current supplied to the motor for driving the hand 17 for movement at a predetermined reduction ratio. More concretely, if the hand 17 moving in the moving direction X collides with an obstacle, a current indicated by the specified current command and flowing in the same direction as the current supplied to the hand moving device 32 immediately before the collision is reduced at the predetermined reduction ratio. Regarding the current supplied to the pitch changing motor 31, a current indicated by the specified current command and corresponding to currents flowing in opposite directions is reduced at the predetermined reduction ratio. If the hand 17 moving in the vertical direction Z collides with an obstacle, a current indicated by the specified current command and corresponding to a current flowing in the same direction as a current supplied to the pitch changing motor 31 immediately before the collision is reduced at the predetermined reduction ratio. Regarding the current supplied to the hand moving device 32, a current indicated by the specified current command and corresponding to currents flowing in opposite directions is reduced at the predetermined reduction ratio.

The current reducing unit 26 has a limiting unit 56 and a current direction finding unit 57. At a stage before the detection of the collision of the hand 17 with an obstacle, the limiting unit 56 does not limit the current while the current indicated by the specified current command is within the set current range and gives a driving current command to the current generating circuit 22.

Upon the reception of a collision detection signal, the current direction finding unit 57 finds the flowing direction of the current and gives a current limitation command including information about the direction of the current to the limiting unit 56. When the current flowing only in the direction found by the current direction finding unit 57 is to be limited, the limiting unit 56, upon the reception of the current limitation command, reduces a current flowing in the same direction and indicated by the specified current command at the predetermined reduction ratio and gives a driving current command indicating the reduced current to the current generating circuit 22. When the current limitation command is give to the limiting unit 56 and the currents flowing in opposite directions are to be limited, the current limiting unit 56 reduces currents corresponding to the opposite currents and indicated by the specified current command at the predetermined ratio and gives a driving current command indicating the reduced currents to the current generating circuit 22.

Upon the reception of a specified current command indicating a current flowing in a direction opposite the direction of a current found by the current direction finding unit 57, the limiting unit 56 does not limit the specified current even if the specified current is higher than the upper limit of the set current range or lower than the lower limit of the set current range and gives a driving current command indicating the specified current to the current generating circuit 22.

Upon the reception of the separation completion signal indicating the separation of the hand 17 from the obstacle from the internal position command producing unit 48, the limiting unit 56 stops operating in an unlimiting mode for giving a driving current command indicating the unlimited specified current to the current generating circuit 22 and starts operating in a normal limiting mode for giving a driving current command indicating a current in the set current range to the current generating circuit 22. Thus the internal position command producing unit 48 serves as an overcurrent supply mode canceling means for canceling an overcurrent supply mode.

A current limiting mode may be canceled when the current direction finding unit 57 finds the reversal of the specified current indicated by the specified current command and gives the limiting unit 56 a current limitation cancellation command to that effect.

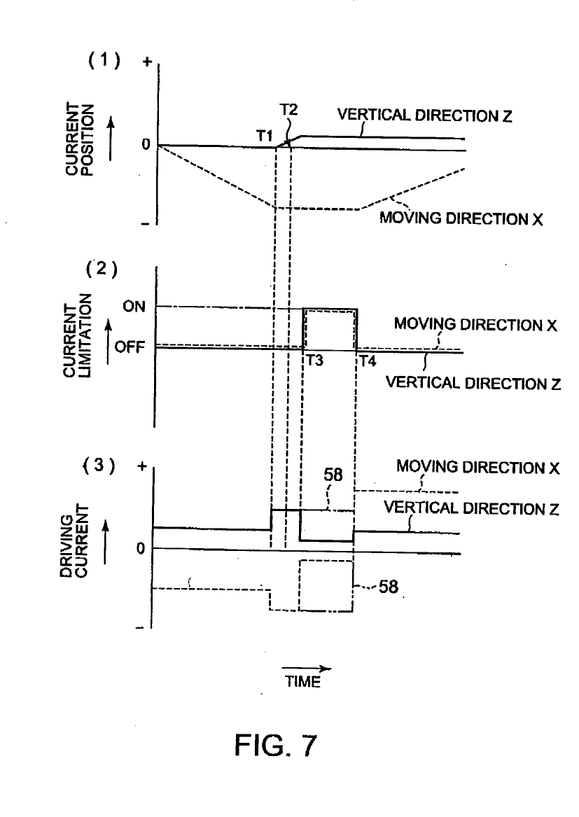

A control procedure to be executed by the controller 13 when the hand 17 moving in the moving direction X collies with an obstacle will be described. FIG. 6 is a flow chart of the control procedure. FIGS. 7(1), 7(2) and 7(3) show the variation of the current position of the hand 17, the current limiting mode and the driving current with time. In FIG. 7(1) a continuous line indicates the time variation of the current position of the hand 17 with respect to the vertical direction Z, and a broke line indicates the time variation of the current position of the hand 17 with respect to the moving direction X. In FIG. 7(2), a continuous line indicates the change with time of a current limiting mode in which the current limiting unit 26 limits the current supplied to the pitch changing motor 31, and a broken line indicates the change with time of a current limiting mode in which the current limiting unit 26 limits the current supplied to the hand moving device 32. In FIG. 7(3), a continuous line indicates the ideal mode of change with time of the driving current supplied to the pitch changing motor 31 and a broken line indicates the ideal mode of change with time of the driving current supplied to the hand moving device 32.

In step a0, the controller 13 produces a position command to move the hand 17 in the moving direction X and adjusts the driving currents supplied to the pitch changing motor 31 and the hand moving device 32 so that the hand 17 may be moved along a predetermined route. When the hand 17 is moved at a fixed velocity in the moving direction X, the position of the hand 17 with respect to the moving direction X changes linearly with time and the position of the hand 17 with respect to the vertical direction Z is fixed as shown in FIG. 7(1). Under an ideal condition, the driving currents are fixed as shown in FIG. 7(3). Suppose that the hand 17 comes with an obstacle at collision time Ti. Then, the control procedure is started in step a1.

In step a1, the collision of the hand 17 with an obstacle is detected from the stop of the advancement of the hand 17 in the moving direction X and the dislocation of the hand 17 in the vertical direction Z. When the hand 17 collides with the obstacle, the difference between the value provided by the rotary encoder 21 and the movement command increases. Then, the current indicted by the specified current command is increased. If the current indicated by the specified current command exceeds the set current range, the current limiting unit 26 detects limits the increase of the driving current indicated by the driving current command and currents corresponding to the upper or the lower limit of the set current range are supplied to the pitch changing motor 31 and the hand moving device 32.

Upon the collision of the hand 17 with the obstacle, the collision detecting unit 24 executes a collision detecting step. After the detection of the collision of the hand 17 with the obstacle at collision detection time T2, step a2 is executed.

In step a2, the current limiting unit 26 starts the current limiting step at current limitation start time T3 to further limit the driving currents supplied to the pitch changing motor 31 and the hand moving device 32. The step a3 is executed.

In step a3, a movement limiting step and a position maintaining step are executed. The command producing unit 25 produces a hand retracting command and a position maintaining command. The hand retracting command and the position maintaining command are given respectively to the hand moving unit 32 and the pitch changing motor 31. Consequently, a current necessary for maintaining the hand 17 at a position with respect to the vertical direction Z to which the hand 17 has been dislocated by the collision is supplied to the pitch changing motor 31, and a current reverse to a current which has been supplied to the hand moving unit 32 is supplied to the hand moving unit 32.

The start of current limitation is delayed by a first delay time W1 from the collision detection time T2. The reversal of the current supplied to the hand moving unit 32 is delayed by a second delay time W2 from the collision detection time T2. The start of supplying the current necessary to hold the hand 17 at the current position to the pitch changing motor 31 is delayed by the second delay time W2 from the collision detection time T2. For example, the first delay time W1 is on the order of several milliseconds and the second delay time W2 is on the order of several tens milliseconds. The first delay time W1 is far shorter than the second delay time W2. At reverse movement start time T4 when the reverse current is supplied to the hand moving device 32 and the current for maintaining the hand 17 at the current position to which the hand 17 has been dislocated by the collision after the collision detection time T2, step a4 is executed.

Step a4 is started at the reverse movement start time T4. The current limiting unit 26 does not limit the current and gives a driving current command indicating the specified current to the current generating circuit 22. Then, the current generating circuit 22 supplies the reverse driving current reverse to the current which has been supplied before the collision to the hand moving device 32 and supplies the current for maintaining the hand 17 at the current position with respect to the vertical direction Z to the pitch changing motor 31. Consequently, the hand 17 kept at the current position with respect to the vertical direction Z is retracted in the direction opposite the moving direction X.

The current limiting unit 26 executes the overcurrent supply step and gives a driving current command indicating an unlimited specified driving current to the current generating circuit 22. Consequently, a high driving current can be supplied to the hand moving device 32 to retract the hand 17 promptly.

Step a5 is executed after the internal position command producing unit 48 decides that the hand 17 separated from the obstacle has been retracted away from the obstacle by a predetermined distance.

In step a5, the internal position command producing unit 48 produces an internal command requesting stopping moving the hand 17 and gives a separation completion signal to the current limiting unit 26 to make the current limiting unit 26 stop operating in the overcurrent supply mode and start operating in the normal current limiting mode. Then, the controller 13 ends the control procedure for driving the motors after the hand 17 has collided with an obstacle.

The operator rewrites the program if the moving route of the hand 17 is improper. The operator removes the obstacle, makes sure that the hand 17 does not collide with the obstacle, and operates an input device, such as a teaching pendant, to give a restart signal to the controller 13. Consequently, the selector switch 55 is operated to establish a state where the hand 17 can be moved according to the position command provided by the external position command producing unit 37.

As obvious from the foregoing description, the first delay time W1 between the detection of the collision of the hand 17 with an obstacle and the start of limiting the current is shorter than the second delay time W2 between the detection of the collision of the hand 17 with an obstacle and the start of reversing the current supplied to the hand moving device 32 and supplying the current to the pitch changing motor 31. Therefore, a pushing force that may be exerted by the hand 17 on the obstacle before the reverse movement start time T4 can be suppressed by limiting the driving current by the current limiting unit 26. Thus impacts on the hand 17 and the obstacle can be eased.

If the driving current is not limited, for example, driving currents higher than those supplied to the pitch changing motor 31 and the hand moving device 32 before the collision are supplied continuously to the pitch changing motor 31 and the hand moving device 32 after the hand 17 has collided with an obstacle until the reverse movement start time T4 as indicted by two-dot chain lines in FIG. 7(3). Consequently, the hand 17 continues pushing the obstacle by a large force and hence impact resulting from the collision cannot be eased.

The present invention can ease impact resulting from the collision by limiting the driving currents supplied to the pitch changing motor 31 and the hand moving device 32. Thus damage to the pitch changing motor 31, the hand moving device 32, reduction gears, the arm and the obstacle caused by the collision can be reduced.

The configuration of the current limiting unit 26 can be very easily realized by updating the program stored in the storage unit of the controller. The method of easing impact resulting from the collision by limiting the currents supplied by the current generating circuit 22 does not have any relation with the collision detecting method. Therefore the detection of the collision of the hand 17 with an obstacle will not be delayed.

The reverse current is supplied to the hand moving device 32 at the reverse movement start time T4 to start retracting the hand 17. Thus the hand 17 can be promptly retracted to separate the hand 17 from the obstacle in a short time after the collision.

The supply of the current necessary for maintaining the hand 17 at the position with respect to the vertical direction Z to which the hand 17 has been dislocated by the collision to the pitch changing motor 31 is started at the reverse movement start time T4. Consequently, the hand 17 cannot make a motion to return from the current position to a position where the hand 17 has been before the collision and the hand 17 can be prevented from further pushing the obstacle in the vertical direction Z. Thus the hand 17 not pushing the obstacle in the vertical direction Z can be retracted to separate the hand 17 from the obstacle.

Although the control operations to be carried out when the hand 17 collides with an obstacle during movement in the moving direction X, damage to the band 17 and the obstacle caused by the collision can be reduced by similarly carrying out the control operations when the hand 17 comes into oblique collision with an obstacle in which hand 17 comes obliquely into collision with the obstacle. More concretely, a force necessary for moving the hand 17 in an oblique moving direction is decomposed into a horizontal force for moving the hand 17 in the moving direction X and a vertical force for moving the hand 17 in the vertical direction Z. The horizontal and the vertical force are controlled coordinately to control the movement of the hand 17. Upon the collision of the hand 17 with an obstacle, the internal position command producing unit 25 produces internal position commands and gives the same respectively to the pitch changing motor 31 and the hand moving device 32 to reverse the moving direction of the hand 17 in a direction opposite a direction in which the hand 17 has been moving before the collision and to hold the hand 17 at a position with respect to the vertical direction Z to which the hand 17 has been dislocated by the collision. The hand 17 is prevented from being pushed in a direction perpendicular to the moving direction in which the hand has been moved before the collision and, at the same time, the hand 17 can be separated from the obstacle by thus controlling the pitch changing motor 31 and the hand moving device 32.

The current limiting unit 26 limits the current supplied to the hand moving device 32 before the collision and does not limit the reverse current supplied to the hand moving device 32 after the collision. Thus the reverse current can be immediately supplied to the hand moving unit 32 even if the second delay time W2 between the detection of the collision and the time the current is reversed is variable depending on the velocity of the hand 17. Therefore, the time current limitation is to be stopped does not need to be precisely determined and hence convenience can be improved.

If a specified current command indicating a specified current higher than the upper limit of the set current range is given after the reversal of the specified current indicated by the specified current command, the current limiting unit 26 does not limit the current indicated by the specified current command and gives the specified current command as a driving current command to the current generating circuit 22 so that the hand moving device 32 produces a large reverse torque. Consequently, time for which the hand 17 pushes the obstacle can be further shortened. In the normal state, the flow of a current exceeding the upper limit of the set current range and a current below the lower limit of the set current rage is prevented to prevent damaging the current generating circuit 22, the pitch changing motor 31 and the hand moving unit 32.

Flow of high currents for a long time through the current generating circuit 22, the pitch changing motor 31 and the hand moving device 32 can be prevented by starting a normal current limiting mode when it is decided that the hand 17 has been separated from the obstacle. Thus damaging the current generating circuit 22, the pitch changing motor 31 and the hand moving unit 32 can be prevented.

The current limiting unit 26 limits a specified current calculated by the movement determining unit 23 and indicated by the specified current command. There is a time lag between the time the command producing unit 25 receives a collision detection signal and the time an internal position command is given to the movement determining unit 23. Since the movement determining unit 23 has a feedback system, there is a time lag between the time an internal position command is given and the time a specified current command is given to the current limiting unit 26. Limitation of a driving current indicated by a driving current command can be achieved regardless of delay caused by the servomechanism. Therefore, a time between the detection of the collision and the production of a driving current command indicating a driving current determined by limiting the specified current indicated by the specified current command is shorter than a time needed for producing the specified current command. Therefore, a driving current indicated by the driving current command can be calculated before the specified current indicated by the specified current command is calculated after the detection of the collision. Thus the currents supplied to the pitch changing motor 31 and the hand moving device 32 can be promptly reduced before the currents supplied to the pitch changing motor 31 and the hand moving device 32 are reversed after the detection of the collision or before the current necessary for maintaining the hand 17 at the position to which the hand 17 has been dislocated by the collision is supplied.

Preferably, the currents limited by the current limiting unit 26 and supplied to the supplied to the pitch changing motor 31 and the hand moving device 32 are zero or the lowest possible currents to ease impact caused by the collision of the hand 17 with the obstacle. If high currents are supplied to the pitch changing motor 31 and the hand moving device 32, the pushing force exerted by the hand 17 on the obstacle cannot be satisfactorily reduced even after the current limitation start time T3 when limiting high currents flowing through the pitch changing motor 31 and the hand moving device 32 is started.

If an external force, such as gravity, acts on the hand 17, a current limited by the current limiting unit 26 and supplied to the motor M is not lower than a current necessary to generate a torque sufficient to prevent the hand 17 from being dislocated by the external force, such as gravity. Thus the undesirable dislocation of the hand 17 can be avoided and the hand 17 can be prevented from being caused to fall down by its own weight.

If an external force acts on the hand 17, the lowest necessary current for maintaining the robot in a desired position may be calculated on the basis of the weight of the hand 17 and torque that can be produced by the motor M, and a driving current command indicating the calculated current may be given to the current generating circuit 22. A reduction ratio suitable for determining the calculated current indicated by the current command may be set beforehand. A reduction ratio calculated for each of different positions or the predetermined reduction ratio may be selectively used according to the condition of the hand 17.

The collision detecting unit 24 of the controller 13 in this embodiment calculates an estimated velocity deviation and an estimated acceleration deviation on the basis of the displacements of the hand 17 with respect to the vertical direction Z and the moving direction X and detects the collision on the basis of the calculated estimated velocity deviation and the calculated estimated acceleration deviation. Thus the collision of the hand 17 with an obstacle can be detected if the hand 17 is displaced in either the vertical direction Z or the moving direction X.

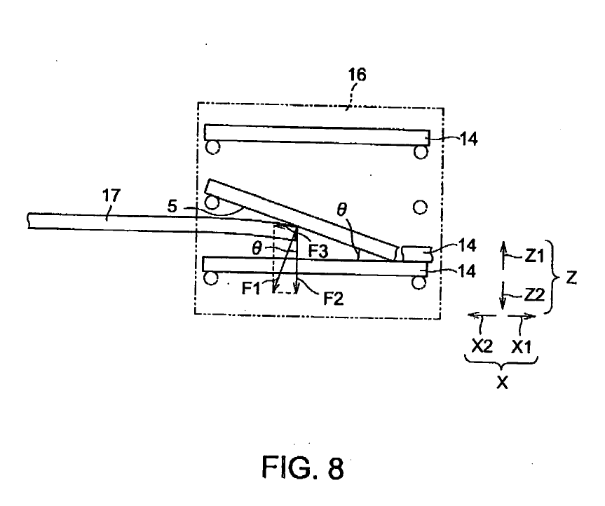

FIG. 8 shows the hand 17 and a wafer 14 after the hand 17 has come into oblique collision with the wafer 14 in a side elevation. Wafers 14 are densely arranged in the vertical direction Z in the cassette 15 and on the wafer boat 16 to minimize the system. Therefore, it is highly possible that the hands 17 of the robot 11 for carrying the wafers 14 come into oblique collision with the wafers 14. In most cases, the collision angle θ, namely, the angle between the hand 17 and the wafer 14 with which the hand 17 has collided, is in a range between an angle greater than 0° and an angle below 45° (0°<θ<45°). The collision angle θ is the smallest one of angles between the moving direction X of the hand 17 and a surface of the wafer 14 with which the hand 17 has collided. A force F1 acting in a direction perpendicular to the surface of the wafer 14 with which the hand 17 collided acts on the hand 17. Then, the wafer 14 exerts a vertical component force F2=F1×sin θ acting in the vertically downward direction Z2 and a horizontal component force F3 acting in the reverse moving direction X2=F1×cos θ opposite the moving direction X on the hand 17. Since 0°<θ<45°, the vertical component force F2 is greater than the horizontal component force F3 (F2>F3). Consequently, the hand 17 is more likely to be dislocated than in the moving direction X, and the estimated velocity deviation and the estimated acceleration deviation with respect to the vertical direction Z is greater than those with respect to the moving direction X. The collision detecting unit 24 detects the collision on the basis of at least either of the estimated velocity deviation and the estimated acceleration deviation with respect to the vertical direction Z for accurate collision detection.

The controller 13 in this embodiment can accurately detect the collision of the hand 17 with the obstacle on the basis of the external position command and the information provided by the rotary encoder. If the collision of the hand 17 with the obstacle is detected, for example, on the basis of the current supplied to the pitch changing motor 31, the accuracy of the collision detection is subject to the viscosity of the lubricant filled in the joints of the hand 17. For example, the viscosity of the lubricant increases in winter and, consequently, a theoretical current needed by the pitch changing motor 31 increases remarkably even under a normal condition. Such increase in the theoretical current due to the increase in the viscosity of the lubricant, in some cases, can be mistaken for collision. This embodiment of the present invention can accurately detect the collision of the hand 17 with an obstacle on the basis of the information provided by the rotary encoder and the position command regardless of the variation of the current supplied to the pitch changing motor 31.

Since the collision of the hand 17 with an obstacle is detected on the basis of the external position command and the information provided by the rotary encoder, any sensor capable of actually sensing the collision of the hand 17 with an obstacle is unnecessary and the arithmetic circuit of the computer can serve as a collision detecting means. Thus collision sensors including proximity sensors, limit switches and acceleration sensors are not necessary. Since a decision that the hand 17 collided with an obstacle is made on the basis of the estimated velocity deviation and the estimated angular velocity deviation, complicated calculations, such as calculations for solving equations of motion defining motions of the hand 17, are unnecessary, and the collision can be detected in a short time.

Collision detection and arm control can be achieved by updating the control program to be executed by the robot controller. Thus the collision detecting unit 24 and the command producing unit 25 can be incorporated into the robot in a short time. The physical constitution may be similar to a known physical constitution.

The method of controlling the motor M after the occurrence of the collision clears the result of integration to eliminate the current command provided to continue the operation of the motor M before the collision, and gives a current command to hold the hand 17 at the position with respect to the vertical direction Z to which the hand 17 has been dislocated and to retract the hand 17. That is, a current action of the driver on the driven member is stopped, and then the driver retracts the driven member along the retracting route. Thus the hand 17 can be promptly retracted after the collision and the movement of the hand 17 can be promptly resumed.

If the integrated current command is not reset when the hand 17 collides with an obstacle, for example, even if a primary current command indicating a current necessary for maintaining the hand 17 at a position with respect to the vertical direction Z to which the hand 17 has been dislocated is calculated, a specified current command indicating a current necessary for maintaining the hand 17 at the position with respect to the vertical direction Z to which the hand 17 has been dislocated can not be promptly given to the current generating circuit 22 because the adder 46 adds up the integrate current command indicating the velocity of the hand 17 before the collision and the primary current command. Consequently, a long time is spent before the pushing force exerted by the hand 17 on the obstacle is reduced.

An operation for maintaining the hand 17 at the position with respect to the vertical direction Z to which the hand 17 has been dislocated can be achieved promptly by resetting the integrated current command after the collision and the pushing force exerted by the hand 17 on the obstacle can be reduced.

A controller 13 in another embodiment according to the present invention includes a current limiting unit 26 having a function to limit the current supplied to the pitch changing motor 31 to a value necessary at least for maintaining the position of the hand 17 with respect to the vertical direction Z while the hand 17 is moving in the moving direction X and limits the current supplied to the hand moving device 32 to a value necessary at least for maintaining the position of the hand 17 with respect to the moving direction X while the hand 17 is moving in the vertical direction Z in addition to those of the current limiting unit 26 of the foregoing embodiment.

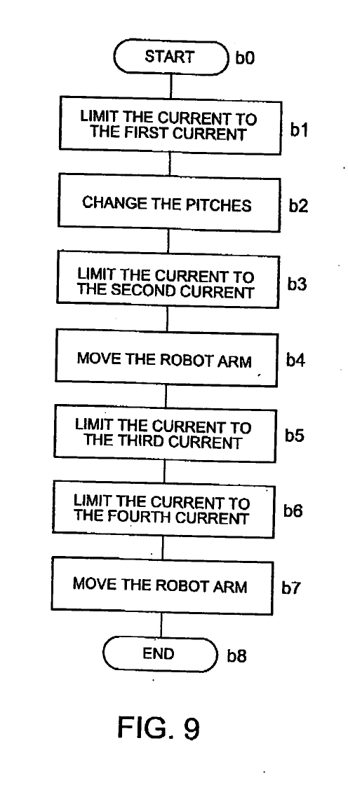

FIG. 9 is a flow chart of a control procedure to be carried out by the controller to unload the wafer 14 from the wafer boat 16. A control procedure to be carried out by the controller 13 to limit the current supplied to the pitch changing motor 31 will be described. The control procedure is started in step b0 after a process for processing the wafers 14 held by the wafer boat 16 has been completed. Then, the control procedure goes to step b1.

In step b1, the current limiting unit 26 limits the current supplied to the pitch changing motor 31 to a first current. The first current is higher than a current necessary for moving hands 17 not loaded with any wafers 14 in the vertical direction Z. Then, step b2 is executed.

In step b2, a movement determining unit 23 produces a specified current command indicating a current for adjusting the vertical pitches of the hands 17 to that of the wafers 14 held on the wafer boat 16 and gives the specified current command to the current limiting unit 26. If the specified current indicated by the specified current command is lower than the first current, the current limiting unit 26 does not limit the specified current and transmits the specified current command directly to a current generating circuit 22. The current generating circuit 22 supplies a current equal to the specified current indicated by the specified current command to the pitch changing motor 31. Step b3 is executed after the vertical pitches of the hands 17 have been adjusted to those of the wafers 14 held on the wafer boat 16.

In step b3, the current limiting unit 26 limits the current supplied to the pitch changing motor 31 to a second current. The second current supplied to the pitch changing motor 31 can maintain at least the positions of the hands 17 with respect to the vertical direction Z. The hands 17 in this embodiment are formed such that the respective gravitational effects thereof counterbalance each other. Therefore, the hands 17 can be held at a position with respect to the vertical direction Z even if any current is not supplied to the pitch changing motor 31 in an ideal state unless a force is applied to the hands 17. Therefore, the second current may be as low as zero. Step b4 is executed after the current supplied to the pitch changing motor 31 has been limited to the second current.

In step b4, the movement determining unit 23 produces a specified current command indicating a current for moving the hands 17 in the moving direction X to insert the hands 17 into spaces between the adjacent wafers 14 held on the wafer boat 16 and gives the specified current command to the current limiting unit 26. If the current indicated by the specified current command is lower than the second current, the current limiting unit 26 does not limit the current and gives the specified current command as a driving current command to the current generating circuit 22. Then, the current generating circuit 22 supplies a current indicated by the driving current command to a hand moving device 32. Step b5 is executed after the hands 17 have been moved in the moving direction X and have been advanced into the spaces between the adjacent wafers 14 vertically arranged in the vertical direction Z on the wafer boat 16.

In step b5, the current limiting unit 26 limits a current supplied to the pitch changing motor 31 to a third current. The third current is higher than a current necessary for holding the hand 17 loaded with a wafer 14 in a predetermined position against a force acting in the vertically downward in the vertical direction Z on the hand 17. A moving device 28 moves a substrate holding device 27 upward in the vertical direction Z to support the wafers 14 on the hands 17, respectively. Then, step b6 is executed.

In step b6, the current limiting unit 26 limits a current supplied to the pitch changing motor 31 to a fourth current. The fourth current is a current necessary for holding the hands 17 supporting the wafers 14 thereon at positions with respect to the vertical direction Z. Then, step b7 is executed after the current supplied to the pitch changing motor 31 has been limited to the fourth current.

In step b7, the movement determining unit 23 produces a specified current command indicating a current for retracting the hands 17 in a direction opposite the moving direction X to separate the hands 17 from the wafer boat 16. The specified current command is given to the current limiting unit 26. The current limiting unit 26 does not limit the current indicated by the specified current command is lower than the fourth current and gives the specified current command as a driving current command to the current generating circuit 22. The current generating circuit 22 supplies a current indicated by the driving current command to the hand moving device 32. Step b8 is executed after the hands 17 have been separated from the wafer boat 16. In step b8, the controller 13 ends the control procedure for unloading the wafers 14 from the wafer boat 16.

The control procedure shown in FIG. 9 is carried out when the hand 17 does not collided with an obstacle when the wafers 14 are unloaded from the wafer boat 16. The control procedure shown in FIG. 6 to be carried out by the controller 13 when the hand 17 collides with an obstacle is carried out if the hand 17 collides with an obstacle.

Suppose that the hand 17 collides with an obstacle while the hands 17 are being moved in the moving direction X in step b4. The current supplied to the pitch changing motor 31 in step b4 is limited to the second current sufficient to hold the hands 17 at the positions with respect to the vertical directions Z, and hence a repulsive force exerted on the obstacle by the movable body in the vertical direction Z is low. Therefore, if a force acts downward in the vertical direction Z on the hand 17 when the hand 17 collides with an obstacle, the hand 17 can be easily dislocated downward in the vertical direction Z. Consequently, a pushing force exerted by the hand 17 on the obstacle can be reduced and damage to the hand 17 and the obstacle can be reduced.

The hand 17 collided with an obstacle is displaced greatly downward in the vertical direction Z. Therefore, an estimated velocity deviation and an estimated angular velocity deviation caused by the collision are large. Thus a collision detecting unit 24 can accurately detect the collision of the hand 17 with the obstacle. Since the respective magnitudes of the estimated velocity deviation and the estimated angular velocity deviation increases to a level high enough for the collision detecting unit 24 to detect the collision in a short time. Thus the collision detecting unit 24 can detect the collision in a short time after the occurrence of the collision and a process to be started upon the occurrence of the collision can be started in a short time after the occurrence of the collision.

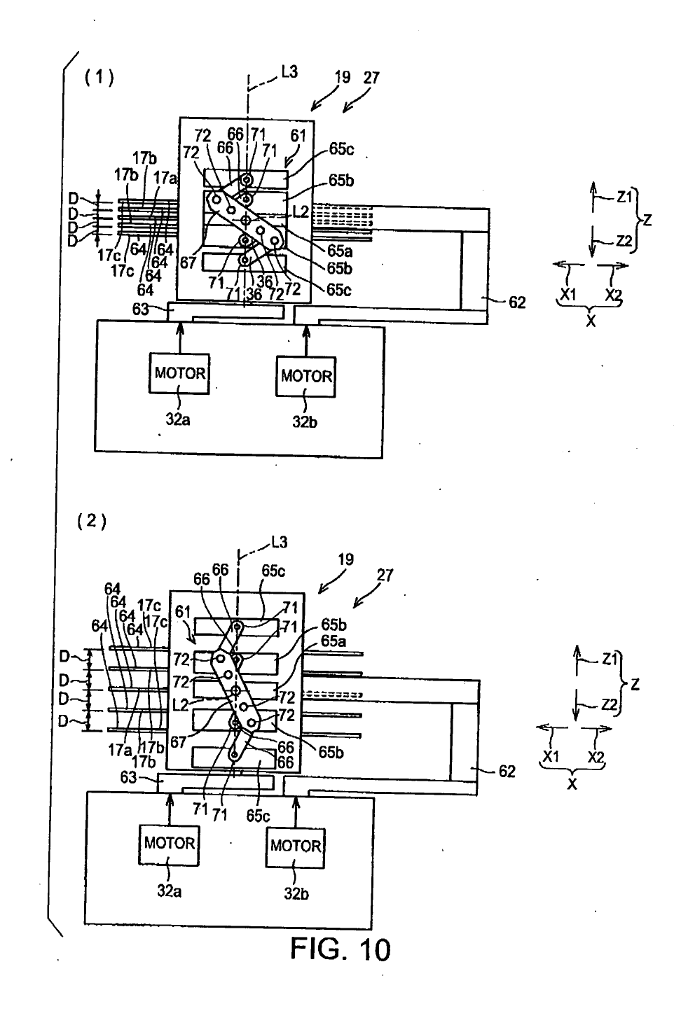

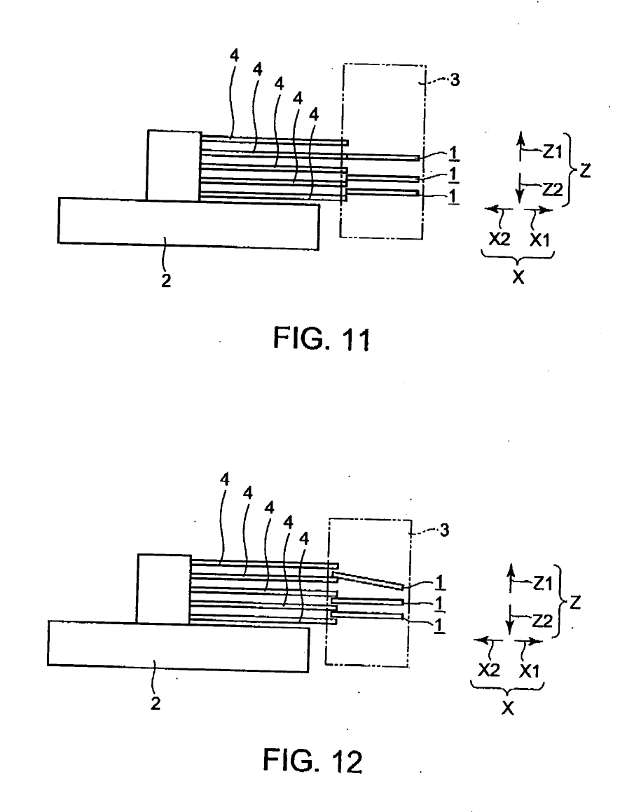

FIGS. 10(1) and 10(2) are views of assistance in explaining a pitch changing operation. FIG. 10(1) shows the hands 17 arranged at small pitches and FIG. 10(2) shows the hands 17 arranged at big pitches.

The robot arm 19 is provided further with a linkage 61 for coordinately moving hands 17, a first movable base 62, and a second movable base 63. A substrate holding device 27 of this embodiment includes a first hand 17a, second hands 17b and third hands 17c. The hand moving device 32 includes a first hand moving motor 32a for moving the first movable base 62 in the moving direction X and a second hand moving motor 32b for moving the second movable base 63 in the moving direction X.

The first hand 17a is a middle hand at the middle of the vertical arrangement of the hands 17. The second hands 17b are on the vertically opposite sides, respectively, of the first hand 17a. One of the third hands 17c is disposed above the second hand 17b disposed above the first hand 17a with respect to an upward vertical direction Z1 the other is disposed below the second hand 17b disposed below the first hand 17a with respect to a downward vertical direction Z2. The first hand 17a, the second hands 17b and the third hands 17c are referred to inclusively as the hands 17 when necessary.

Each of the hands 17 includes a support blade 64 for supporting a wafer 14 thereon and a holding member 65 maintaining the support blade 64. The support blades 64 of the hands 17 have the same shapes, respectively, and are arranged vertically at equal intervals. One of the surfaces of the blade 64 is a support surface. The blades 64 are thin plates. The blades 64 are formed in a thickness of, for example, about 3.5 mm so that the blades 64 can be inserted into spaces between adjacent vertically arranged wafers 14, respectively. The holding member 65a of the first hand 17a is fixed to the first movable base 62. The first movable base 62 is movable in the moving direction X. The first hand moving motor 32a drives the first movable base 62 for movement in the moving direction X. The first hand 17a moves together with the first movable base 62 in the moving direction X.

The respective holding members 65b and 65c of the second hands 17b and the third hands 17c are supported on the second movable base 63 by links 66 and 67. The second movable base 63 is movable in the moving direction X. The second hand moving motor 32b drives the second movable base 63 for movement in the moving direction X. The first movable base 62 and the second movable base 63 can individually move in the moving direction X.

The second movable base 63 is provided with a guide structure for guiding the second hands 17b and the third hands 17c for movement in the vertical direction Z. The respective holding members 65b and 65c of the second hands 17b and the third hands 17c are provided with guided parts engaged with the guide structure, respectively. The second hands 17b and the third hands 17c provided with the guided parts engaged with the guide structure are guided for movement in the vertical direction Z by the guide structure. For example, the guide structure is a vertical guide rail and the guided parts are sliders slidable along the guide rail. The guide rail and the sliders constitute a straight sliding mechanism.

The linkage 61 is an interlocking mechanism for coordinately moving the second hands 17b and the third hands 17c in the vertical direction Z. The linkage 61 formed by combining the driving link 67 and the plurality of driven links 66 so as to be turnable relative to each other for angular displacement. The respective positions and shapes of the links 66 and 67 are determined such that the vertical intervals between the adjacent ones of the blades 64 of the hands 17 change at the same changing ratio when the driving link 67 is turned.

The second hands 17b and the third hands 17c are connected to the links 66, respectively. The hands 17b and 17c have connecting parts 71, respectively. One of the opposite ends of each of the driven links 66 is rotatably connected to the connecting part 71 of each of the hands 17b and 17c. The driven links 66 are turnable on the connecting parts 71 relative to the hands 17b and 17c, respectively. The other ends of the driven links 66 are connected to the driving link 67. The driving link 67 has connecting parts 72 respectively for the links 17b and 17c. The other ends of the driven links 66 are rotatably connected to the connecting parts 72. The driven links 66 are turnable on the connecting parts 72 relative to the driving link 67. Thus the second hands 17b and the third hands 17c are linked to the driving link 67 by the driven links 66, respectively.

In this embodiment, the driving link 67 and the driven links 66 are elongate plates. One of the opposite longitudinal ends of each driven link 66 is rotatably connected to the connecting part 71 of each of the hands 17b and 17c. The respective lengths of the driven links 66 are determined respectively for the hands 17b and 17c. The driving link 67 is turnable about a predetermined reference axis L2. The pitch changing motor 31 drives the driving link 67 for turning about the reference axis L2.

When the driving link 67 is turned abut the reference axis L2 by the pitch changing motor 31, the connecting parts 72 of the driving link 67 are displaced through an angle and the respective positions with respect to the vertical direction Z of the connecting parts 72 change, and the driven links 66 connected to the driving link 67 are turned on the connecting parts 72 accordingly for angular displacement. The hands 17b and 17c are guided for movement in the vertical direction Z by the guide structure such that the connecting parts 71 are always along a first axis L3 extending in the vertical direction Z.

The driven links 66 remain parallel to each other during movement even when the driving link 67 is turned for angular displacement. Thus the intervals between the adjacent ones of the hands 17a, 17b and 17c can be changed at the same changing ratio. That is, the intervals between the hands 17a, 17b and 17c can be changed keeping the pitches D of the hands 17a, 17b and 17c equal to each other.

For example, when the substrate holding device 27 accesses the cassette 15, the pitches D of the hands 17a, 17b and 17c are adjusted so as to coincide with the pitches of the wafers 14 arranged in the cassette 15 as shown in FIG. 10(1). When the substrate holding device 27 accesses the wafer boat 16, the pitches D of the hands 17a, 17b and 17c are adjusted so as to coincide with the pitches of the wafers 14 at which the wafers 14 are arranged on the wafer boat as shown in FIG. 10(2). For example, the pitches D of the hands 17 when the substrate holding device 27 accesses the cassette 15 are smaller than those of the hands 17 when the substrate holding device accesses the wafer boat 16.

The upper one of the two third hands 17c with respect to the upward vertical direction Z1 applies a torque counterclockwise, as viewed in FIG. 10, about the reference axis L2 on to the driving link 67. The lower one of the third hands 13c with respect to the downward vertical direction Z2 applies a torque clockwise, as viewed in FIG. 10, about the reference axis L2 to the driving link 67. When the two third hands 17c are the same in shape and mass, the two third hands 17c produce equal opposite torques, respectively. The equal opposite torques counterbalance each other and hence the third hands 17c do not apply any torque actually on the driving link 67. Similarly, when the two second hands 17b are the same in shape and mass, any actual torque is not applied to the driving link 67 by the two second hands 17b. As mentioned above, the respective gravitational effects of the hands 17 thus counter balance each other. Therefore, the hands 17 can be retained at the same positions with respect to the vertical direction Z even if any current is not supplied to the pitch changing motor 31.

Since the hands 17 of this embodiment are formed such that the respective gravitational effects thereof counterbalance each other, the second current can be as low as zero. Thus a repulsive force exerted by the hand 17 on the obstacle in the vertical direction Z when the hand 17 collides with an obstacle can be reduced to the least possible extent and damage to the hand 17 and the obstacle can be suppressed. Since the repulsive force exerted by the hand 17 on the obstacle in the vertical direction Z when the hand 17 collides with an obstacle can be reduced to the least possible extent, the hand 17 collided with the obstacle is dislocated greatly in the vertical direction Z. Consequently, an estimated velocity deviation and an estimated acceleration deviation are large. The large estimated velocity deviation and estimated acceleration deviation can improve the accuracy of collision detection of the collision detecting unit 24 and can make possible quick collision detection in the shortest possible time.

The collision detecting unit 24 of the controller 13 in the foregoing embodiment detects the collision on the basis of an estimated velocity deviation and an estimated acceleration deviation. The collision detecting unit 24 may detect the collision on the basis of an estimated position deviation. More concretely, an estimated position deviation can be obtained by subtracting information about an estimated position from information about a measured current position. The collision detecting unit Z4 decides that the hand 17 collided with an obstacle when the estimated position deviation exceeds a third threshold.

The collision detecting unit 24 may produce a collision detection signal on the basis of at least one of the estimated position deviation, the estimated velocity deviation and the estimated acceleration deviation. Thus the controller 13 can accurately detect the collision of the hand 17 with an obstacle. The collision detecting unit 24 of this embodiment calculates an estimated velocity deviation on the basis of feedback velocity information obtained by differentiating data provided by the rotary encoder. If an accelerometer is employed, an estimated acceleration deviation may be calculated on the basis of information provided by the accelerometer, and the collision may be detected from the estimated acceleration deviation.

The collision detecting unit in another embodiment may detect the collision of the hand 17 with an obstacle on the basis of a specified current command. More concretely, it is decided that the hand 17 collided with an obstacle when the movement determining unit 23 provides an abnormal specified current command different from a normal specified current command which is provided in a normal state. For example, a specified current command indicating a specified current to be supplied to the pitch changing motor 31 while the hand 17 is moving in the moving direction X is substantially equal to zero in the normal state. When the hand 17 collides with an obstacle, the hand 17 is dislocated in the vertical direction Z from a normal position where the hand 17 is retained in the normal state. Then, a specified current command indicating a current higher than the current substantially equal to zero to restore the dislocated hand 17 to its normal position. The collision detecting unit 24 detects the collision from this specified current command.

The collision detecting unit of another embodiment may detect the collision not only from the displacement of the hands 17 in the vertical direction Z by the pitch changing motor 31 and the dislocation of the hands 17 in the moving direction X by the hand moving device 32, but also from the angular displacement of the hands 17 about the axis L1 by the moving device 28 for moving the substrate holding device 27 and the displacement of the hands 17 in the vertical direction Z by the moving device 28. In some cases, the substrate holding device 27 including the hands 17 turns about the axis L1 or is dislocated in the vertical direction Z when the hand 17 collides with an obstacle. Use of such a dislocation for collision detection can improve the accuracy of collision detection.

The command producing unit in another embodiment of the present invention may produce a command requesting moving the hand 17 by a predetermined distance in a direction in which the hand 17 has been dislocated by the collision from a position to which the hand 17 has been dislocated by the collision. When the hand 17 collides with an obstacle, the hand 17 is thus shifted in a direction perpendicular to the moving direction. Thus the obstacle can be surely prevented from being pushed by the hand 17 after the collision. The predetermined distance is determined so that the hand 17 may not come into collision with another obstacle when the hand 17 is moved by the predetermined distance in the direction perpendicular to the moving direction.

The command producing unit in another embodiment of the present invention may calculate a retraction route on the basis of information indicated by a retraction command given by operating the teaching pendant 36 or information about a route stored in the storage unit 34.

The current limiting unit in another embodiment of the present invention may be provided with a timer for timing stopping current limitation by the current limiting unit 26 at the reverse movement start time T4 instead of the current direction finding unit 57. The timer gives a current limiting command to the limiting unit 56 upon the reception of a collision detection signal. The limiting unit 56 limits the specified current indicated by the specified current command regardless of the direction of the current.

Upon the passage of the second delay time W2 necessary for reversing the direction of the current, the timer gives a current limitation stopping command to the limiting unit 56, and then the limiting unit 56 stops limiting current limitation to permit the flow of a current not lower than the upper limit of the set current range. Thus the limitation of the current supplied to the motor is prevented and the specified current command can be given as a driving current command to the current generating circuit 22. Upon the reception of the separation completion signal, the limiting unit 56 terminates the overcurrent supply mode and starts the normal current limiting mode.

The controller provided with the current limiting unit of another embodiment has the same effects as the foregoing controller. In this case, the direction of the current supplied to the motor before the collision does not need to be found from the specified current command.

The current limiting unit in an embodiment may stop limiting the current when a limitation stopping signal is given thereto by the arithmetic unit 33 or by an input device, such as the teaching pendant 36.

According to the present invention, although it is preferable to detect the collision of the hand with an obstacle on the basis of the estimated position deviation, the estimated velocity deviation and the estimated acceleration deviation, there is not any particular restriction on the method of detecting the collision of the hand 17 with an obstacle; the collision of the hand 17 with an obstacle may be detected by any suitable, known method.

Although the present invention has been described as applied to a control method of controlling the robot and the controller for carrying out the same, the present invention is applicable also to a control method and a controller for controlling an apparatus including a driving system for driving a movable body for movement. For example, the present invention is applicable not only to controlling a driving system including electric motors, but also to a control method and a controller for controlling a driving system including hydraulic or pneumatic driving devices. Industrial machines other than robots, such as numerically controlled machines (NC machines) and carrying apparatus, controlled by the foregoing control methods and the foregoing controllers can exercise effects similar to those mentioned above.

The movement determining unit 23 may have a configuration other than the foregoing configuration. Although the constitution of the calculators is realized by reading the program by the controller 13 in the foregoing embodiments, the constitution of the calculators may be realized by physical means, such as electric circuits. The controller 13 of the present invention and the robot controller may be separate controllers. When the current indicated by the specified current command is reversed, a driving current command indicating a driving current obtained by amplifying the given specified current indicated by the specified current command at a predetermined gain may be given to the current generating circuit. Thus the time for which the hand 17 is pressed against the obstacle can be further reduced.

Although the invention has been described in its preferred embodiments with a certain degree of particularity, obviously many changes and variations are possible therein. It is therefore to be understood that the present invention may be practiced otherwise than as specifically described herein without departing from the scope and spirit thereof.

1. A driving mechanism controller for controlling a driving mechanism for driving a movable body for movement, said driving mechanism controller comprising a command producing means capable of giving the driving mechanism
a movement restricting command requesting restricting movement of the movable body driven by the driving mechanism for movement in a moving direction in which the driving mechanism has been moving the movable body before the movable body collides with an obstacle, and
a position maintaining command requesting maintaining the movable body at a position with respect to a direction perpendicular to the moving direction to which the movable body has been displaced by collision in response to a collision detection signal given thereto by a collision detecting means upon detection of the collision of the movable body driven by the driving mechanism with the obstacle.

2. The driving mechanism controller according to claim 1, wherein the driving mechanism includes a first driving device for driving the movable body for movement in a predetermined first direction and a second driving device for driving the movable body for movement in a second direction perpendicular to the first moving direction, and
the command producing means giving the driving mechanism a moving direction reversing command requesting reversing the moving direction of the movable body being moved in the first moving direction and a position maintaining command requesting maintaining the movable body at a position with respect to the second direction to which the movable body has been displaced by the collision upon the collision of the movable body moving in the first moving direction with the obstacle.

3. The driving mechanism controller according to claim 1 further comprising:
a current limiting means for limiting currents supplied to first and second electric motors respectively serving as the first and the second driving device in response to the collision detection signal; and
a current generating circuit capable of generating currents to be supplied to the first and the second electric motors on the basis of a command provided by the current limiting means.

4. The driving mechanism controller according to claim 3, wherein the current limiting means limits a current to be supplied to the second electric motor below a current needed by the second electric motor to move the movable body in the second direction, while the movable body is being moved in the first moving direction.

5. The driving mechanism controller according to claim 4 further comprising the collision detecting means;
wherein the collision detecting means detects the collision of the movable body with an obstacle on the basis of a displacement of the movable body in the second direction.

6. The driving mechanism controller according to claim 1 further comprising the collision detecting means;
wherein the collision detecting means detects the collision of the movable body with an obstacle on the basis of a displacement of the movable body in a direction in which the driving mechanism moves the movable body and a displacement of the movable body in a direction perpendicular to the moving direction.

7. A robot comprising:
a hand;
a driving mechanism for driving the hand for movement; and
the driving mechanism controller according to claim 1.

8. A driving mechanism control method of controlling a driving mechanism for driving a movable body for movement, said driving mechanism control method comprising the steps of:
detecting a collision of the movable body driven by the driving mechanism with an obstacle;
restricting movement of the movable body in a moving direction in which the movable body is moved before the movable body collides with the obstacle upon the detection of the collision of the movable body with the obstacle;
maintaining the movable body at a position to which the movable body has been displaced in a direction perpendicular to the moving direction by the collision upon the detection of the collision of the movable body with the obstacle.

9. A program intended to be executed by a computer to carry out the driving mechanism control method according to claim 8.
